(19) United States
(12) Patent Application Publication
(10) Pub. No.: US 2024/0378337 A1
(43) Pub. Date: Nov. 14, 2024

(54) MINE STRESS FIELD TWIN MODELING ASSIMILATION SYSTEM FOR FULL SPACE-TIME MINING PROCESS, AND METHOD

(71) Applicant: CHINA UNIVERSITY OF MINING AND TECHNOLOGY, Beijing (CN)

(72) Inventors: Wei YANG, Jiangsu (CN); Zening WEI, Jiangsu (CN); Yingte FENG, Jiangsu (CN); Wenxiao ZHANG, Jiangsu (CN); Wenyuan WANG, Jiangsu (CN)

(21) Appl. No.: 18/293,864

(22) PCT Filed: Mar. 27, 2023
(86) PCT No.: PCT/CN2023/084076

§ 371 Date: Jan. 31, 2024

(30) Foreign Application Priority Data
Mar. 28, 2022 (CN) 202210312223.6

(51) Int. Cl. G06F 30/17; G06T 17/05

(52) U.S. Cl. CPC G06F 30/17; G06T 17/05

(57) ABSTRACT

The present invention relates to a mine stress field twin modeling assimilation system for a full space-time mining process, and a method, and belongs to the technical field of digital twin assimilation inversion. The system comprises a digital model unit, a physical model unit and a human-computer interaction unit. The digital model unit is provided with an equal-proportion three-dimensional geological model, a mine historical assimilation model and a trusted digital twin model; the physical model unit covers a stratum and a mining face tunnel system, and the human-computer interaction unit has an information database and a software simulation monitoring interface. By means of a software establishment model, assimilation technology optimization model operation and a digital twin technology interconnection physical entity and virtual model, the present invention is able to construct a mine in-situ stress field twin model aimed at a full space-time mining process and better approximating reality, and is likewise able to use real physical scene monitoring data to perform simulated pre-mining in a virtual spatial model, aimed at grasping the space-time evolution laws of stress fields in the mining process, and providing guidance for safe mining production.

### TECHNICAL FIELD

The present invention relates to a twin modeling and assimilation system for mine stress field in full time-space mining process and a method thereof, and belongs to the technical field of digital twin modeling, assimilation and inversion.

### BACKGROUND ART

With the gradual depletion of coal resources in shallow mines, the mining depth of mines in China increases continuously in order to ensure energy supply. For example, in the central and eastern regions, the mining depth advances deeper at a rate of 10˜25 m/a, and reaches 800-1,000 m. There are several thousand-meter-deep wells. With the increase of the mining depth, the ground stress also increases continuously. The study shows that the ground stress is the fundamental driving force for the deformation and damage of the surrounding rock in underground engineering such as coal mining, and it is one of the most important factors leading to disasters such as coal and gas outburst and rock burst. The higher the ground stress is, the more intense the change is and the greater the outburst risk is. Outburst accidents dominated by the ground stress in outburst coal seams in China are increasing continuously, which is not conducive to safe and efficient production and construction in mines.

In the process of mining coal resources, mining response is inevitable. However, in the actual mining process, the mining sequence may result in the change of the initial ground stress field and the change of stress concentration and distribution in the surrounding rocks, and may easily induce dynamic disasters such as rock bursts and severe deformation of surrounding rocks of roadways, etc.

Although the ground stress is one of the most important factors leading to dynamic disasters, the conventional ground stress testing methods (e.g., stress recovery method, overcoring stress relief method, hydraulic fracturing method, etc.) are cumbersome in operation, difficult in technology and low in accuracy. Therefore, the ground stress has not been an effective parameter for early warning and prevention of outburst accidents under mining disturbance for a long time.

Presently, the development of computer simulation technology and big data processing technology provides new ideas and methods for prevention and control of dynamic disasters in outburst mines. on one hand, through comprehensive investigation and comprehensive analysis of related historical data of exploration, construction, mining and maintenance in the mining area, combined with the super-high simulation operation ability of computers, a large-scale full time-space numerical model of the mining area is established to inverse the mining work in the mining area, thereby large-scale numerical simulation of the entire mining cycle of the mine can be realized, and the law of distribution and evolution of the mining stress field can be analyzed. In addition, combined with historical data of dynamic disasters in the mining area and the measured data of the current working face the calculation result of the model are compared, so as to improve the accuracy and reliability of numerical calculation of assimilation and analysis, and provide a technical support for the evolution analysis of the mining stress field. On the other hand, combining advanced digital twinning technology with contemporary coal mining, promoting extensive intelligent analysis and simulation control and optimization of coal mines has become a research hotspot.

### SUMMARY OF THE INVENTION

To solve the problems existing in the prior art, the present invention provides a twin modeling and assimilation system and method for mine stress field in a full time-space mining process. By combining the assimilation and inversion technology with the advanced concept of digital twining technology, a three-dimensional entire mine stratum model that is more consistent with the actual situation can be established, and the value of historically measured data is fully mined with assimilation technology to further optimize the calculation results of the model, thereby improving the accuracy and fineness of stress inversion. In addition, simulated pre-mining can be carried out in a virtual space model according to the monitoring data of the real physical scene, so as to master a time-space evolution law of the stress field in the entire life cycle of coal mining and provide guidance for safe production in mines.

To attain the above objective, the twin modeling and assimilation system for mine stress field in a full time-space mining process provided by the present invention includes a digital model unit, a physical model unit, and a human-machine interaction unit, where the human-machine interaction unit realizes data interaction and sharing between the digital model unit and the physical model unit, establishes a two-way information flow channel, ensures the consistency between the physical entity and the virtual model of the twin system, and provides functions of synchronization between the physical entity and the virtual model and feedback monitoring;
the digital model unit first establishes an equal-proportion three-dimensional geological model with software modeling technology according to the mine construction data, then trains the geological model with assimilation and inversion technology according to the historical data to obtain a assimilation model of mine history, and finally maps measured state parameters of the mine physical entities to the assimilation model of mine history with digital twinning technology to obtain a credible digital twin model;
physical model unit is configured to record strata of the mining area and data of the roadway system in each mining face of the mine;
human-machine interaction unit includes an information database, a command stream editor and a simulation monitoring interface; the mine construction data, historical monitoring data and twining data, including physical entity attribute values, field measured values and sensor data, are inputted into the information database, and then a command stream is written to process and update the data, and finally the data is fed back to the simulation monitoring interface for query and control.

A twin modeling and assimilation method for mine stress field in a full time-space mining process is provided, including:
step 1: establishing an initial equal-proportion three-dimensional geological model:
obtaining geological information of an entire mine from detailed borehole data for the geological exploration in the entire mine, including three-dimensional coordinates of tops and bottoms of coal seams and characteristic rock strata at borehole positions, and calculating the three-dimensional coordinates of any point at the tops and bottoms of the coal seams and the characteristic rock strata by an interpolation method; obtaining distribution and mechanical properties of the coal seams and the rock strata from the borehole data and geological report data;
obtaining three-dimensional coordinates of boundary control points of all mining sections and key roadways by using a secondarily developed CAD software CASS v10.1, according to a layout of all completed mining sections and key roadways in the entire mine and a layout of unmined mining sections and key roadways in the mine, combined with the three-dimensional coordinates of any point at the tops and bottoms of the coal seams and the characteristic rock strata;
establishing an equal-proportion three-dimensional numerical calculation model of the mine, which includes all mining sections and key roadways under complex topographic conditions, by using a FLAC3D software or a 3DEC software, according to distribution characteristics of faults in the mine, surface relieves, boundaries of the mine, three-dimensional coordinates of any point at the tops and bottoms of the coal seams and the characteristic rock strata, and three-dimensional coordinates of boundary control points of all mining sections and key roadways; assigning values to parameters of different coal seams and rock strata in the model and applying constraint boundaries to the model by a conventional method; applying vertical stress according to a dead weight of the model, and applying horizontal stress to the geological model according to lateral pressure coefficients to deform the geological model; running the geological model by the FLAC3D or 3DEC software to complete the deformation, until an initial stress balance state is reached;
step 2: establishing a historical equal-proportion three-dimensional geological model:
defining a mining sequence of the completed mining sections and key roadways in the entire mine according to the historical data, simulating mining operations in all mining sections and key roadways in the entire mine sequentially with the equal-proportion three-dimensional geological model established in the step 1 by using the FLAC3D or 3DEC software, where the mining sequence in the numerical simulation is the same as the historical mining sequence, calculating a law of ground stress evolution with time in the mining process in the entire mine, and continuously recording stress and displacement data of all key locations in the entire process of the geological model calculation, until the stimulated mining process reaches a current real state of mining in the mine; and a final calculation result includes historical stress evolution data of the mine and current stress distribution data of the mine;
comparing the historical data of the entire mine with data of key points in the mine model, which comprises: obtaining the historical data, comprising data of ground stress monitoring points, mine outburst information recorded by a monitoring department of the mine, and observation data of coal and rock strata displacement, comparing the historical data with simulation data of a series of key points in the equal-proportion three-dimensional geological model obtained in the step 1, modifying parameters in the model according to the actual data, and running the geological model again, so that results calculated with the geological model are consistent with time and key locations of coal and gas outburst accidents in history, as well as coordinates and types of outbursts in history, obtaining a final inversion calculation result of the ground stress field of the mine is obtained; adjusting the assigned parameters in the assigned geological model with the calculation result, and running a reassigned geological model, so that calculation results are consistent with the historical data of the key locations in the mine, and the equal-proportion three-dimensional geological model in the step 1 is perfected into a mine history assimilation model that can reflect a natural law and empirical knowledge of mine operation history;
step 3: establishing a credible digital twin model that realistically simulates changes of the coal and rock mass around the roadways in real mining operation:
digitally describing a state of a real ground stress environment of the physical entity based on the mine history assimilation model established in the step 2, establishing a credible digital twin model faithfully mapping the physical entity, and continuously tracking real-time data input into the physical entity, especially change state values of ground stress and rock surface displacement, through the human-machine interface, so as to realistically reflect change characteristics of ground stress magnitude, ground stress distribution and rock surface displacement of the coal and rock mass around the roadways in the mining operation;
specifically, field ground stress measurement is performed by using an overcoring stress relief method and a drilling cuttings measurement method, measured points in unmined areas are selected, and the rock surface displacement is monitored in real time from an observation station; the measured data is compared with data of corresponding locations in the credible digital twin model, parameters of the credible digital twin model are modified and the model is run again, so that calculated results of the credible digital twin model is consistent with data of ground stress and displacement in a series of measured locations, and the calculated result of the credible digital twin model can be considered as an accurate inversion result of the ground stress field of the mine. In addition, the mine environment, roadway mining state information and downhole sensor data are acquired, digitally processed and uploaded to the human-machine interface, and mapped into the digital model in real time. Thus, the mine history assimilation model is a truly credible digital twin model.

In the step 1, the entire mine refers to a complete area including a plurality of mining sections which interact with each other in the mining process, the number of sections is more than 10 and the minimum horizontal distance between adjacent mining sections is less than 200 m; the characteristic rock strata refers to rock strata that can play a key role in roof movement and stress evolution in the mining process and usually have greater strength or thickness. The key roadways usually refer to sectional return-air roadways, sectional hauling roadways and open-off cutting roadways located in the coal seam; all completed mining sections and key roadways refer to all mining sections and key roadways from the beginning of the mining to the present. A conventional method for model setting is to complete the modeling process by using built-in commands and writing a command stream. The assigned parameters mainly include bulk modulus, shear modulus, density, tensile strength, internal friction angle, elastic modulus and Poisson's ratio.

The key locations mentioned in the step 2 refer to ground stress testing locations, historical outburst locations where dynamic disasters have occurred, and coal and rock strata displacement observation locations, etc. specifically, related data mainly comes from the historical geological data and archives of the mining area sorted out by the geological exploration department of the mine and the mine outburst cards sorted out by the ventilation department.

In the step 3, a series of measured locations refer to unmined system roadways, floor gas drainage roadways, coal roadway heading heads, open-off cutting locations of the mining face, and surface rock stratum corresponding to the working face. Specifically, the magnitude of the ground stress is measured by a stress-relief method, the distribution of the ground stress field is measured by a drilling cuttings measurement method, and surface rock movement is monitored from an observation station.

Based on the initial equal-proportion three-dimensional geological model established in the step 1, the historical process is “reproduced” in the real mining sequence in the mine to the current state, simulated data of a series of key locations is compared with the historical measured data, and the simulated data of a series of measured locations are compared with the current measured data. A deviation coefficient γ=|x_{historical measured data}−x_{result of the model}|/x_{historical measured data}×100% is defined; if the deviation coefficient is less than 10%, it can be considered that the calculation result of the equal-proportion three-dimensional geological model is consistent with the real situation, and the assimilation of the model is completed. Otherwise, the parameters of the equal-proportion three-dimensional geological model will be modified and the model is run repeatedly, until the calculation result meet the requirements.

The parameters of the credible digital twin model are modified, i.e., mechanical parameters of coal and rock mass and the magnitude and direction of the ground stress are modified continuously according to the reproduced historical data. The initial state parameter set remains unchanged after it is determined in the step 1.

The continuous modification mainly includes two processes: In the first process, a small simplified numerical model of the equal-proportion three-dimensional geological model is established to simulate mining of the small simplified numerical model. The same numerical calculation parameters as those of the equal-proportion three-dimensional geological model are used. the mechanical parameters of the small simplified numerical model, including cohesion, internal friction angle, elastic modulus and Poisson's ratio, are modified according to a law of stress distribution and a law of the surrounding rock deformation in the mining process simulated by the small simplified numerical model, so that numerical simulation results are essentially consistent with the field measurements. In the second process, the mechanical parameters determined in the first process are brought into the equal-proportion three-dimensional geological model for operation. In the process, owing to the change of stress value and occurrence environment, the law of stress distribution and the law of the surrounding rock deformation may deviate from that in the small simplified numerical model. Thus, the parameters are modified, so that the law of mechanical distribution and the law of deformation in the equal-proportion three-dimensional geological model are consistent with the field measurements, and the assimilation is completed.

There are beneficial effects. In the present invention, an equal-proportion three-dimensional geological model is established on the basis of comprehensive investigation and comprehensive analysis of related historical data of exploration, construction, mining, maintenance in a mining area in the early stage. The running values of the model are continuously approached to the real data by using assimilation analysis technology, and the parameter setting of the calculation model is continuously improved so that the results of the model are basically consistent with the historical data and the measured data in the current state, and the temporal and spatial evolution and distribution characteristics of the spatial stress field in the mining operation are obtained, a virtual twin model of a mine physical entity of the mine is established with a concept of digital twinning, and faithful mapping, dynamic interaction and real-time feedback between the physical model and the digital model are realized through a human-machine interface. The present invention focuses on the mechanism of stress response and outburst dynamic disasters in the sequential mining process in coal mines, comprehensively utilizes the innovative achievements of scientific and technological revolutions such as three-dimensional modeling, numerical simulation, assimilation analysis, digital twinning, etc., establishes an equal-proportion three-dimensional geological model based on the initial data of well construction and completion. The model evolves synchronously with the physical entities in historical time and space in combination with historical data. The mine history assimilation model can be used to describe the historical process of the real physical domain entities from the beginning to the present. Finally, through accurate mapping and collaborative interaction with digital twinning the mine history assimilation model is transformed into a truly credible digital twin model. Thus, the value of the historical information resources is deeply explored, and a numerical model for the mine stress field in a full time-space mining process in the entire mine is established, which can provide a data support for the prevention and control of outburst dynamic disasters and assist safe and efficient mining in mines.

### BRIEF DESCRIPTION OF DRAWINGS

FIG. 1 is a schematic diagram of the twin modeling and assimilation system for mine stress field in a full time-space mining process according to the present invention;

FIG. 2 is a schematic block diagram of the digital twin modeling and assimilation process in an embodiment of the twin modeling and assimilation method for mine stress field in a full time-space mining process according to the present invention;

FIG. 3 is a schematic diagram of the three-dimensional stratum model of the entire mine in the embodiment of the present invention;

FIG. 4 is a layout diagram of key locations in the embodiment of the present invention;

FIG. 5 is a layout diagram of measurement locations in the embodiment of the present invention.

### EMBODIMENTS

Hereunder some embodiments of the present invention will be further described with reference to the accompanying drawings.

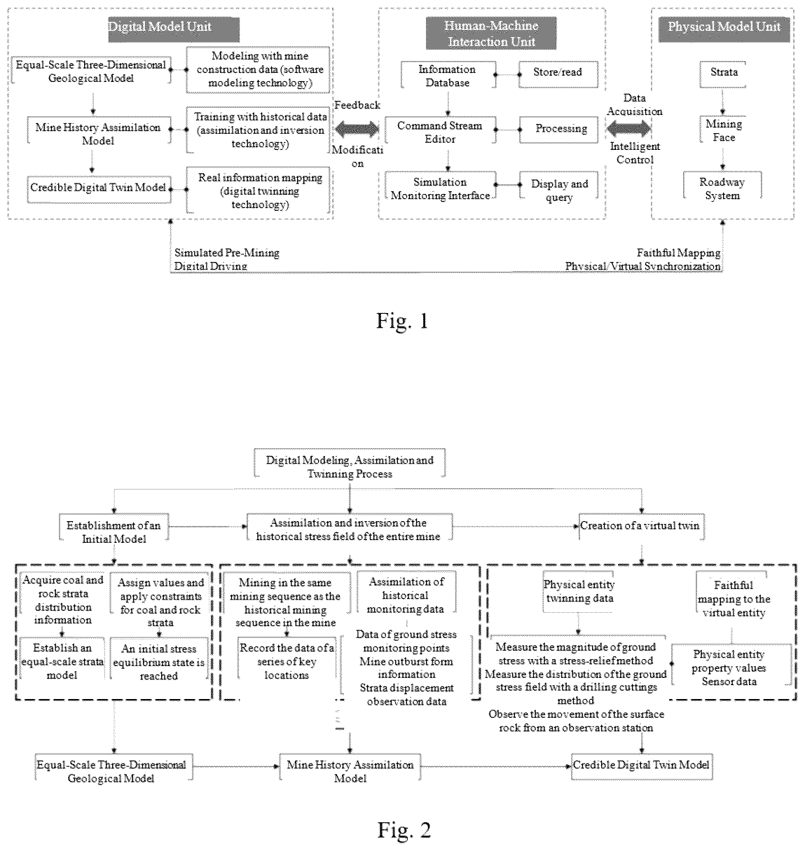

As shown in FIG. 1, a twin modeling and assimilation system for mine stress field in a full time-space mining process includes a digital model unit, a physical model unit, and a human-machine interaction unit, where the human-machine interaction unit realizes data interaction and sharing between the digital model unit and the physical model unit, establishes a two-way information flow channel, ensures the consistency between the physical entities and the virtual model of the twin system, and provides functions of synchronization between the physical entity and the virtual model and feedback monitoring.

The digital model unit first establishes an equal-proportion three-dimensional geological model according to the mine construction data with software modeling technology, then trains the geological model with assimilation and inversion technology according to the historical data to obtain an assimilation model of mine history, and finally maps measured state parameters of the mine physical entities to the assimilation model of mine history with digital twinning technology to obtain a credible digital twin model.

The physical model unit is configured to record strata of the mining area and data of the roadway system in each mining face of the mine.

The human-machine interaction unit includes an information database, a command stream editor and a simulation monitoring interface. The mine construction data, historical monitoring data and twining data, including physical entity attribute values, field measured values and sensor data, are inputted into the information database, and then a command stream is written to process and update the data, and finally the data is fed back to the simulation monitoring interface for query and control.

As shown in FIG. 2, a twin modeling and assimilation method for mine stress field in a full time-space mining process includes steps 1-3.

In step 1, an initial equal-proportion three-dimensional geological model is established.

Geological information of an entire mine is obtained from detailed borehole data for the geological exploration in the entire mine, which includes three-dimensional coordinates of tops and bottoms of coal seams and characteristic rock strata at borehole positions. The three-dimensional coordinates of any point at the tops and bottoms of the coal seams and the characteristic rock strata are calculated by an interpolation method. Distribution and mechanical properties of the coal seams and the rock strata are obtained from the borehole data and geological report data.

The three-dimensional coordinates of boundary control points of all mining sections and key roadways are obtained by using a secondarily developed CAD software CASS v10.1, according to the layout of all completed mining sections and key roadways in the entire mine and a layout of unmined mining sections and key roadways in the mine, combined with the three-dimensional coordinates of any point at the tops and bottoms of the coal seams and the characteristic rock strata.

An equal-proportion three-dimensional numerical calculation model of the mine which includes all mining sections and key roadways under complex topographic conditions is established by using FLAC3D software or 3DEC software, according to distribution characteristics of faults in the mine, surface relieves, boundaries of the mine, three-dimensional coordinates of any point at the tops and bottoms of the coal seams and the characteristic rock strata, and three-dimensional coordinates of boundary control points of all mining sections and key roadways. Values are assigned to parameters of different coal seams and rock strata in the model, and constraint boundaries are applied to the model by a conventional method. Vertical stress is applied according to a dead weight of the model, and horizontal stress is applied to the geological model according to lateral pressure coefficients to deform the geological model; running the geological model by the FLAC3D or 3DEC software to complete the deformation, until an initial stress balance state is reached.

In step 2, a historical equal-proportion three-dimensional geological model is established.

The mining sequence of the completed mining sections and key roadways in the entire mine is defined according to the historical data, the mining work in all mining sections and key roadways in the entire mine is sequentially simulated with the equal-proportion three-dimensional geological model established in the step 1 by using the FLAC3D or 3DEC software. The mining sequence in the numerical simulation is the same as the historical and real mining sequence. A law of ground stress evolution with time in the mining process in the entire mine is calculated, and stress and displacement data of all key locations in the entire process of the geological model calculation is continuously recorded, until the stimulated mining process reaches a current real state of mining in the mine. A final calculation result includes the historical stress evolution data of the mine and the current stress distribution data of the mine.

The historical data of the entire mine is compared with data of key points in the mine model. Specifically, historical data is obtained, such as data of ground stress monitoring points, mine outburst information recorded by a monitoring department of the mine, and observation data of coal and rock strata displacement. The simulation data of a series of key points in the equal-proportion three-dimensional geological model obtained in step 1 is compared with real data, the parameters in the model are modified according to the real data, and then the geological model is run again, so that results calculated with the geological model are consistent with time and key locations of the coal and gas outburst accidents in history, as well as coordinates and types of the outbursts in history. A final inversion calculation result of the ground stress field of the mine is obtained; the assigned parameters in the assigned geological model are adjusted with reference to the calculation result, and a reassigned geological model is run, so that calculation results are consistent with the historical data of the key locations in the mine, so that the equal-proportion three-dimensional geological model in the step 1 is perfected into a mine history assimilation model that can reflect a natural law and empirical knowledge of mine operation history.

In step 3, a credible digital twin model that realistically simulates changes of the coal and rock mass around the roadways in real mining operation is established.

Based on the mine history assimilation model established in the step 2, a state of the real ground stress environment of the physical entity is digitally described, a credible digital twin model faithfully mapping the physical entity is established, and the real-time data input into the physical entity is continuously tracked through the human-machine interface, especially change state values of ground stress and rock surface displacement, so as to realistically reflect change characteristics of ground stress magnitude, ground stress distribution and rock surface displacement of the coal and rock mass around the roadways in the mining operation.

Specifically, field ground stress measurement is performed by using an overcoring stress relief method and a borehole measurement method, measuring points in unmined areas are selected, and monitoring the rock surface displacement is monitored in real time from an observation station; the measured data is compared with data of corresponding locations in the credible digital twin model, parameters of the credible digital twin model are modified and the model is run again, so that the calculated result of the credible digital twin model is consistent with data of ground stress and displacement in a series of measured locations, and the calculated result of the credible digital twin model can be considered as an accurate inversion result of the ground stress field of the mine. In addition, the mine environment, roadway mining state information and downhole sensor data are acquired, digitally processed, and uploaded to the human-machine interface, and mapped into the digital model in real time. Thus, the mine history assimilation model is a truly credible digital twin model.

### Example

A mining area in Shaanxi Province is taken as the object to carry out experimental research. The mining area is a typical mining area with high outburst risk in China, and a coal mine A in the mining area is a typical ground stress-dominated outburst mine. This example is explained with reference to the stress field inversion shown in the figures, to facilitate understanding the functions and characteristics of the present invention better.

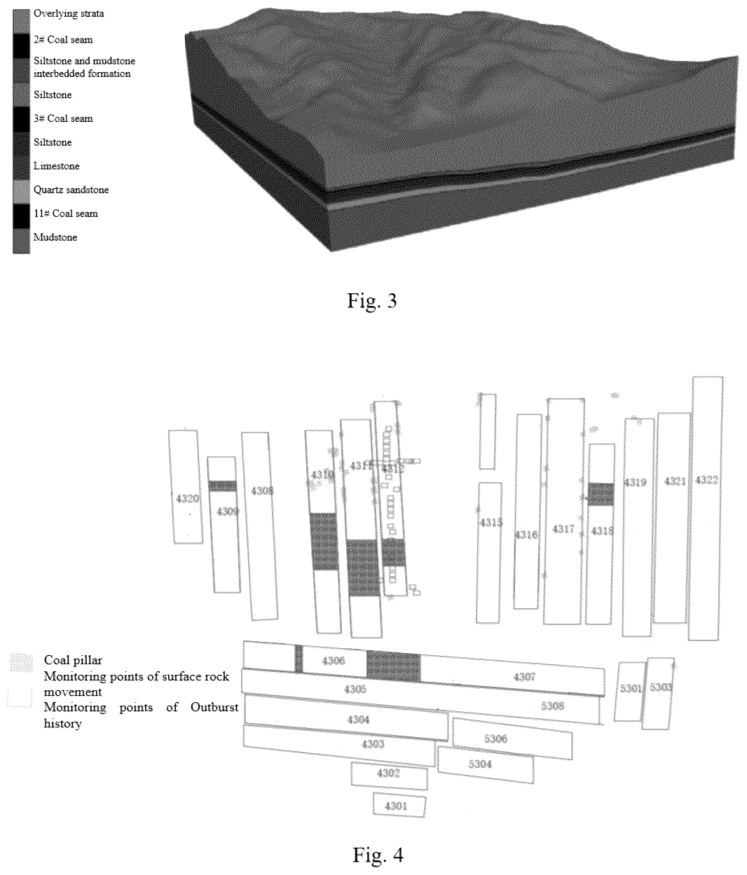

In S1, an initial model is established, as shown in FIG. 3.

In S11, detailed borehole data for geological exploration in the entire mine A, a plan of mining engineering, a comparison diagram between downhole and surface, and borehole data, etc., are collected. According to the borehole data, distribution of coal and rock strata is obtained, and the rock strata are categorized into characteristic strata, such as sandstone formation, mudstone formation, limestone formation, etc., and the mechanical property information of each characteristic strata is obtained according to the geological report data. According to floor contour and geological borehole data, the three-dimensional coordinates of the tops and bottoms of the coal seams and characteristic rock strata at the borehole locations are obtained; the three-dimensional coordinates of any point at the tops and bottoms of the coal seams and characteristic rock strata are calculated by an interpolation method. The three-dimensional coordinates of boundary control points of all mining sections and key roadways are obtained by using a secondarily developed CAD software CASS v10.1, according to a layout of all completed mining sections and key roadways in the entire mine as well as a layout of unmined mining sections and key roadways in the mine, in conjunction with the three-dimensional coordinates of any point at the tops and bottoms of the coal seams and the characteristic rock strata. A three-dimensional full simulation calculation model is established, according to distribution characteristics of faults in the mine, surface relieves, mine boundaries, three-dimensional coordinates of any point at the tops and bottoms of the coal seams and characteristic rock strata, and three-dimensional coordinates of boundary control points of all mining sections and key roadways. In view that the span of the model will be too large and there will be too many meshes and the calculation will be slow if one model is established for the entire mine, and the three mining areas of the mine can be simplified as separate ones without response to each other because they are spaced apart from each other by more than 500 m. Thus, the model of the mine is divided into three modules according to the layout of the mining areas in the mine. An equal-proportion three-dimensional numerical calculation model of the mine including all mining sections and key roadways is established by a FLAC3D software according to the divided areas. gradient meshes are used for the division of the model meshes in order to reduce the calculation load as much as possible on the premise of ensuring the calculation accuracy.

In S12, values are assigned to different rock strata in the model based on the parameters collected in the step S12 according to Mohr-Coulomb Criterion. Vertical stress is applied according to the dead weight of the model, the direction of the maximum principal stress is preliminarily judged according to the outburst history, and horizontal stress is applied preliminarily with a lateral pressure coefficient; constraint boundaries are imposed on the model, then the model is run to an initial stress balance state for trial operation.

In S2, stress evolution history and current stress distribution calculation of the entire mine are shown in FIG. 4.

In S21, according to the mining sequence of the completed mining sections and key roadways in the entire mine, the mining operations of all mining sections and key roadways in the entire mine are sequentially simulated by the FLAC3D software, where the mining sequence in the numerical simulation is the same as the historical sequence, and mining sequence inversion is realized, and a law of the mine stress field distribution in the coal mine at present is obtained; data of a series of key locations such as stress and displacement is continuously recorded in the entire process of model calculation, where the key locations include locations of historical outburst accidents, and locations of ground stress measurement, etc.

In S22, the above stimulated mining process in the same sequence as historical mining sequence is performed until the current real state of mining is reached, and data of a series of measured locations in the current state, such as stress and displacement, etc., including data of measured points of ground stress, measured points of drilling cuttings, and the surface rock movement of the mining face (e.g., working face No. 4312) is recorded; the final calculation result includes the historical stress evolution data and the current stress distribution data of the mine.

In S3, the model is assimilated.

In S31, mine outburst information of is obtained, the stress direction during the outbursts is preliminarily judged according to the field situation in the mine outburst information, and is compared with the stress change of the monitoring points during the model calculation to judge whether the stress direction leading to the outbursts is consistent; if a consistent comparison result is obtained, it indicates that the direction of ground stress is correct; otherwise it indicates that there is a deviation between the direction of ground stress in the model and the real situation. The stress direction is realized by modifying the lateral pressure coefficient and a shear stress value. The monitoring data of coal roadway displacement and stress in the historical mining process (in the mining face No. 4312) is analyzed, to analyze the trend of change, and is compared with the evolution of the stress value of the corresponding points in the model. If they match each other (the error is smaller than or equal to 10%), the stress assignment is correct. If they do not match each other (the error is greater than 10%), the stress magnitude and the mechanical parameters of the rock mass are modified on the premise of ensuring the matching of stress directions, until the stress evolution matches the stress evolution history in the historical mining process.

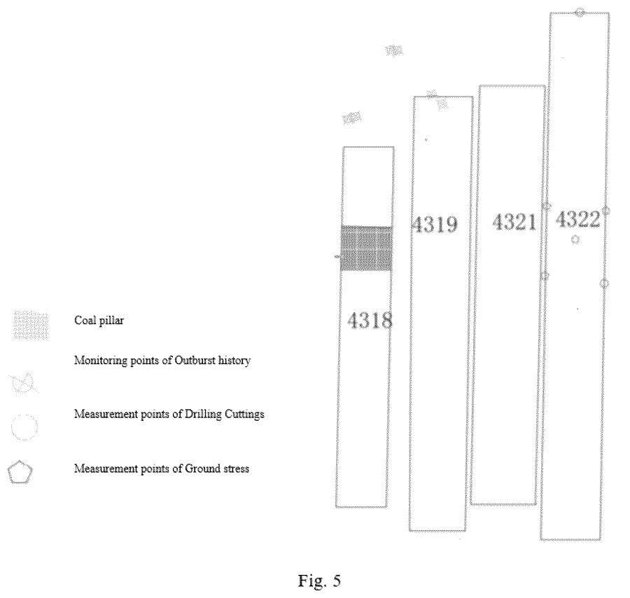

In S32, field ground stress measurement is performed by an overcoring stress relief method, and measured points are selected in unmined roadways (auxiliary roadway No. 240 in the second northern mining area) and floor gas drainage roadways (open-off cut roadway No. 185 in the first southern mining area and hauling roadway No. 4322 in the first northern mining area); the amount of drilling cuttings is measured at the working face (current mining face No. 3319) and the coal tunnel mining head of a mining face respectively; the surface rock displacement at the mining faces (e.g., mining face No. 3319) is observed, collected and recorded with a total station or theodolite, etc.; the measured data is compared with the data of corresponding locations in the model, and the parameters of the numerical model are modified and the numerical model is run again, so that the calculation result of the numerical model is consistent with the measured data of a series of field measurement locations (the error is smaller than or equal to 10%); thus, a final calculation result is obtained, as shown in FIG. 5.

1. A twin modeling and assimilation method for mine stress field in a full time-space mining process, comprising:
step 1: establishing an initial equal-proportion three-dimensional geological model:
obtaining geological information of an entire mine from detailed borehole data in the geological exploration in the entire mine, which comprises three-dimensional coordinates of tops and bottoms of coal seams and characteristic rock strata at borehole positions, and calculating three-dimensional coordinates of any point at the tops and bottoms of the coal seams and the characteristic rock strata by an interpolation method; obtaining distribution and mechanical properties of the coal seams and the rock strata from the borehole data and geological report data;
obtaining three-dimensional coordinates of boundary control points of all mining sections and key roadways by a secondarily developed CAD software CASS v10.1, according to a layout of all completed mining sections and key roadways in the entire mine and a layout of unmined mining sections and key roadways in the mine, combined with the three-dimensional coordinates of any point at the tops and bottoms of the coal seams and the characteristic rock strata;
establishing an equal-proportion three-dimensional numerical calculation model of the mine, which comprise all mining sections and key roadways under complex topographic conditions, by a FLAC3D software or 3DEC software, according to distribution characteristics of faults in the mine, surface relieves, boundaries of the mine, three-dimensional coordinates of any point at the tops and bottoms of the coal seams and the characteristic rock strata, and three-dimensional coordinates of boundary control points of all mining sections and key roadways; assigning values to parameters of different coal seams and rock strata in the model and applying constraint boundaries to the model by a conventional method; applying vertical stress according to a dead weight of the model, and applying horizontal stress to the geological model according to lateral pressure coefficients to deform the geological model; running the geological model by the FLAC3D or 3DEC software to complete the deformation, until an initial stress balance state is reached;
step 2: establishing a historical equal-proportion three-dimensional geological model:
defining a mining sequence of the completed mining sections and key roadways in the entire mine according to the historical data, simulating mining operations in all mining sections and key roadways in the entire mine sequentially with the equal-proportion three-dimensional geological model established in the step 1 by using the FLAC3D or 3DEC software, wherein the mining sequence in the numerical simulation is the same as the historical mining sequence, calculating a law of ground stress evolution with time in the simulated mining process in the entire mine, and continuously recording stress and displacement data of all key locations in the entire process of the geological model calculation, until the stimulated mining process reaches a current real state of mining in the mine; and a final calculation result comprises historical stress evolution data of the mine and current stress distribution data of the mine;
comparing the historical data of the entire mine with data of key points in the mine model; which comprises: obtaining the historical data comprising data of ground stress monitoring points, mine outburst information recorded by a monitoring department of the mine, and observation data of coal and rock strata displacement, comparing the historical data with simulation data of a series of key points in the equal-proportion three-dimensional geological model obtained in step 1, modifying parameters in the model according to the historical data, and running the geological model again, so that a calculation result of the geological model is consistent with time and key locations of coal and gas outburst accidents in history, as well as coordinates and types of outbursts in history, obtaining a final inversion calculation result of the ground stress field of the mine; adjusting assigned parameters in a assigned geological model with the calculation result, and running a reassigned geological model, so that the calculation result is consistent with the historical data of the key locations in the mine, and improving the equal-proportion three-dimensional geological model in the step 1 into a mine history assimilation model that can reflect a natural law and empirical knowledge of mine operation history;
step 3: establishing a credible digital twin model that realistically simulates changes of the coal and rock mass around the roadways in real mining operation:
based on the mine history assimilation model established in the step 2, digitally describing a state of a real ground stress environment of a physical entity, establishing a credible digital twin model faithfully mapping the physical entity, and continuously tracking real-time data input to the physical entity, especially change state values of ground stress and of rock surface displacement through the human-machine interface, so as to realistically reflect change characteristics of ground stress magnitude, ground stress distribution and rock surface displacement of the coal and rock mass around the roadways in the mining operation;
wherein field ground stress measurement is performed by an overcoring stress relief method and a drilling cuttings measurement method, measured points in unmined areas are selected, and the rock surface displacement is monitored in real time from an observation station; the measured data is compared with data of corresponding locations in the credible digital twin model, parameters of the credible digital twin model are modified and the model is run, so that the calculation result of the credible digital twin model is consistent with ground stress and displacement data of a series of measured locations, and the calculation result of the credible digital twin model are considered as an accurate inversion result of the ground stress field of the mine; the mine environment, roadway mining state information and downhole sensor data are acquired, digitally processed, and uploaded to the human-machine interface, and mapped into the digital model in real time; and the mine history assimilation model is a truly credible digital twin model.

2. The twin modeling and assimilation method for mine stress field in a full time-space mining process according to claim 1, wherein a twin modeling and assimilation system for mine stress field in a full time-space mining process comprises a digital model unit, a physical model unit, and a human-machine interaction unit, the human-machine interaction unit realizes data interaction and sharing between the digital model unit and the physical model unit, establishes a two-way information flow channel, ensures consistency between the physical entity and the virtual model of the twin system, and provides functions of synchronization between the physical entity and the virtual model and feedback monitoring;
the digital model unit establishes an equal-proportion three-dimensional geological model with software modeling technology according to the mine construction data, trains the geological model with assimilation and inversion technology according to the historical data to obtain an assimilation model of mine history, and maps measured state parameters of the mine physical entity to the assimilation model of mine history with digital twinning technology to obtain a credible digital twin model;
the physical model unit is configured to record strata of the mining area and data of the roadway system in each mining face of the mine;
the human-machine interaction unit comprises an information database, a command stream editor and a simulation monitoring interface; inputs the mine construction data, historical monitoring data and twining data comprising physical entity attribute values, field measured values and sensor data into the information database, processes and updates the data by writing a command stream, and feeds the data back to the simulation monitoring interface for query and control.

3. The twin modeling and assimilation method for mine stress field in a full time-space mining process according to claim 1, wherein in the step 1, the entire mine refers to a complete area comprising a plurality of mining sections that interact with each other in the mining process, a number of sections is greater than 10 and a minimum horizontal distance between adjacent mining sections is smaller than 200 m; the characteristic rock strata refers to rock strata that can play a key role in roof movement and stress evolution in the mining process and usually have greater strength or thickness; the key roadways usually refer to sectional return-air roadways, sectional hauling roadways and open-off cutting roadways located in the coal seam; all completed mining sections and key roadways refer to all mining sections and key roadways from the beginning of the mining to the present; a conventional method for model setting is to complete the modeling process by using built-in commands and writing a command stream; the assigned parameters mainly comprise bulk modulus, shear modulus, density, tensile strength, internal friction angle, elastic modulus and Poisson's ratio.

4. The twin modeling and assimilation method for mine stress field in a full time-space mining process according to claim 1, wherein the key locations mentioned in the step 2 refer to ground stress testing locations, historical outburst locations where dynamic disasters have occurred, and coal and rock strata displacement observation locations, etc.; specifically, related data mainly comes from the historical geological data and archives of the mining area sorted out by a geological exploration department of the mine and the mine outburst cards sorted out by a ventilation department.

5. The twin modeling and assimilation method for mine stress field in a full time-space mining process according to claim 1, wherein in the step 3, a series of measured locations refer to unmined system roadways, floor gas drainage roadways, roadway heading heads, open-off-cutting locations of the mining face, and surface rock stratum corresponding to the working face; the magnitude of the ground stress is measured by a stress-relief method, the distribution of the ground stress field is measured by a drilling cuttings measurement method, and the surface rock movement is monitored from an observation station.

6. The twin modeling and assimilation method for mine stress field in a full time-space mining process according to claim 1, wherein based on the initial equal-proportion three-dimensional geological model established in the step 1, the historical process is “reproduced” in the real mining sequence in the mine to the current state, simulated data of a series of key locations is compared with the historical measured data, and the simulated data of a series of measured locations are compared with the current measured data; a deviation coefficient γ=|x_{historical measured data}−x_{result of the model}|/x_{historical measured data}×100% is defined; if the deviation coefficient is equal to or smaller than 10%, the calculation result of the equal-proportion three-dimensional geological model is consistent with a real situation and assimilation of the model is completed; otherwise, parameters of the equal-proportion three-dimensional geological model are modified and the model is run until the calculation result meet requirements.

7. The twin modeling and assimilation method for mine stress field in a full time-space mining process according to claim 6, wherein parameters of the credible digital twin model are modified, i.e., mechanical parameters of coal and rock mass and the magnitude and direction of the ground stress are modified continuously according to the reproduced historical data, and an initial state parameter set remains unchanged after it is determined in the step 1;
the continuous modification mainly comprises two processes; in a first process, a small simplified numerical model of the equal-proportion three-dimensional geological model is established to simulate mining of the small simplified numerical model; numerical calculation parameters that are the same as those of the equal-proportion three-dimensional geological model are used, and the mechanical parameters of the small simplified numerical model, comprising cohesion, internal friction angle, elastic modulus and Poisson's ratio, are modified according to a law of stress distribution and a law of deformation of the surrounding rock in the mining process simulated by the small simplified numerical model, so that a numerical simulation result that is essentially consistent with the field measurement; in a second process, the mechanical parameters determined in the first process are brought into the equal-proportion three-dimensional geological model for operation; in the process, owing to the change of stress value and occurrence environment, the law of stress distribution and the law of deformation of the surrounding rock may deviate from that in the small simplified numerical model; the parameters are modified, so that the law of mechanical distribution and the law of deformation in the equal-proportion three-dimensional geological model are consistent with field measurements, and the assimilation is completed.
